(19) United States
(12) Patent Application Publication
(10) Pub. No.: US 2014/0006150 A1
(43) Pub. Date: Jan. 2, 2014

(54) SYSTEMS AND METHODS FOR TARGETING ADVERTISEMENTS BASED ON PRODUCT LIFETIMES

(71) Applicants: Robert Thompson, Broomall, PA (US); William Thomas, Evergreen, CO (US)

(72) Inventors: Robert Thompson, Broomall, PA (US); William Thomas, Evergreen, CO (US)

(73) Assignee: UNITED VIDEO PROPERTIES, INC., Santa Clara, CA (US)

(21) Appl. No.: 13/534,302

(22) Filed: Jun. 27, 2012

(51) Int. Cl. G06Q 30/02

(52) U.S. Cl. 705/14.53

(57) ABSTRACT

Methods and systems for providing improved targeting of advertisements by considering whether or not a particular user is likely to use a particular product, and when the particular user is likely to want or need a product. Two products may be compared to determine if a relationship exists between them, after which a product lifetime is computed for one product. An advertisement for the other product will be shown after the end of the product lifetime for the first product.

### BACKGROUND

In conventional systems, advertisements for a particular product are often directed to specific users or groups that are likely to purchase the product associated with the advertisement. By “targeting” the advertisements towards particular users, systems attempt to maximize the amount of products sold. The products may be goods (e.g., cars, movies, tickets, etc.), services (lawn care, car washes, home repairs, etc.), or a combination of the two (e.g., yearly subscriptions, warranty plans, restaurant gift certificates, etc.).

### SUMMARY OF DISCLOSURE

Accordingly, methods and systems are described herein for improving the targeting of advertisements by considering not only whether or not a particular user is likely to use a particular product, but also when the particular user is likely to want or need the product.

For many products or services, a user is likely to only use or have one of a particular product or service at any particular time. For example, a system may determine that a customer recently purchased a DVD containing the first season of a television show. The system may also determine that the customer will likely purchase the second season as well. However, if the system sends an advertisement too soon after the customer has bought the first season, the customer may disregard the advertisement because the customer still has to watch the remainder of the first season of the show. Likewise, if the system sends an advertisement too late after the customer bought the first season of the show, the customer may have already watched the first season and bought the second season somewhere else. Therefore, the most effective advertisement may be one sent during a period of time beginning when the customer may be interested in purchasing the second season and ending when the customer has likely purchased the second season somewhere else.

In some embodiments, a system may include a server, which transmits a query for purchase history information and product information. For example, the server may request information from other servers or third party devices to determine whether or not a particular product was purchased. If the product was purchased, the system may also retrieve information on the person that purchased the product and when the person purchased the product. Therefore, in order to obtain the required information, the query may comprise a first product identifier for the product and a user identifier for the user.

In some embodiments, the product information may comprise a plurality of data fields used to describe the product. The data fields may comprise textual descriptions of the products or may comprise values associated with specific attributes or traits of the product. In some embodiments, the product information may also comprise a plurality of data fields to describe the user. For example, the data fields may include values associated with specific demographics, or the values may relate to how the particular user interacts with a product (e.g., how long the user typically uses the product).

In some embodiments, the purchase history information may also comprise a plurality of data fields used to describe the purchase. The data fields may comprise textual descriptions of the purchase or may comprise values associated with specific characteristics of the purchase. For example, the data fields may include values associated with the purchase history information regarding when, how or for whom the product was purchased (e.g., whether or not the product was purchased as a gift).

To determine the appropriate time at which to target an advertisement, the system may need to first determine what product is related to the advertised product. This may require determining whether or not a purchased product is typically bought in series with the advertised product. For example, a first movie of a movie trilogy may be related to the second movie in a movie trilogy. Similarly, a yearly magazine subscription for a first year may be related to a yearly magazine subscription for the next year.

In some embodiments, a server may compute a relationship metric between a first product information for a first product and a second product information for a second product. The server may use the computed relationship metric to determine whether or not the first product and the second product are related. For example, the server may compare corresponding data fields for the first product information and the second product information. Upon determining that one or more values of the corresponding data fields are equal, the server may determine that the two products are related. In another example, the server may analyze particular data fields of the first product information and the second product information for particular values or text (e.g., searching for keywords in a textual description field). Upon finding a particular value or text in any one data field, the server may determine that the two products are related.

Once the system has determined whether or not one product is related to another product, the system can then determine the lifetime of that product or service. For example, the product lifetime may begin when a product or service is purchased by the user. In another example, the lifetime of a product or service may begin when a user begins using a product or service, or in the case of perishable goods, when the product or service was created. For example, the lifetime of a subscription may begin when the user purchases the subscription, the lifetime of a book may begin when a user begins to read the book, or the lifetime of fruit may begin when the fruit is grown.

In some embodiments, after determining two products are related, the system may automatically process the first product information and the first purchase history information to compute a lifetime for the first product. For example, in response to determining that two products are related, the system may analyze the purchase history data for the first product to determine when the first product lifetime began.

The system may then use the first product information to determine the duration of that lifetime. For example, the duration of the product lifetime of a movie may be the amount of time a user takes to watch the entirety of the movie. In another example, the duration of a service lifetime may be from when the user subscribed until the subscription expires.

In many cases, the duration of a product or service lifetime will further depend on the particular user. While a monthly subscription may end at the same time for all users, some products or services may depend on the frequency or usage-rate of the particular user. For example, while two users may purchase the same book on the same day, it will likely take the two users different amounts of time to read the book. Furthermore, one of the users may wish to read the book a second time before buying a new book. Therefore, the system may need to develop a profile associated with particular users or groups of users. For example, by tracking a user's purchasing habits, the system may determine that the user purchases a new video game every month. Based on this habit, the system may determine that the product lifetime of a video game purchased by a user is one month.

In some embodiments, to compensate for the variability in product lifetimes based on the user, the system may compute the lifetime of the product using, for example, a weighted arithmetic mean. The system may retrieve user profile information comprising time variables and associated weight values from within the data fields of the first product information. Alternatively, the user profile may be extracted from a different source, separate from the first product information.

After determining when the product lifetime began and the length of the product lifetime based on the particular user, the system can determine the end of the product lifetime. The end of the product lifetime, for example, may be when the user is likely to purchase an advertised product that is related to the user's product, or may be when the user is likely to consider buying an advertised product (which may be before the actual purchase). For example, at some point after obtaining a particular product, a user may decide that the particular product has become outdated, inoperable, completely/sufficiently used or no longer sufficient for its intended purpose, and the user may begin looking for a new or replacement product.

By analyzing the purchase history information data fields, the system can determine when a particular product was purchased or initially used. In addition, by using the sum of the purchase date and computed product lifetime, the system can determine when a user may need or may be looking to purchase a new or related product. Therefore, the system can increase the likelihood that the person will purchase the product by targeting advertisements for the product to the particular person at this particular time.

In some embodiments, the system may compare the current date and the sum of the lifetime of the first product and the beginning date of the first product (e.g., the end date of the product lifetime for the first product) to determine whether or not the current date is outside the lifetime of the first product. In response to this determination, the system may generate an instruction for presenting an advertisement for the second product on a device. In some embodiments, determining whether or not the current date is outside the first product's lifetime may include comparing a value to a particular threshold. For example, the system may use the sum to generate a value for the proximity of the current date to the date that the product's lifetime ends.

In some embodiments, the system may apply statistical methods (e.g., adjusting for standard deviations in a normal distribution), to compute the value associated with the proximity of the current date to the projected end date of the first product's lifetime. For example, if the current date is three days away from the projected end date of the first product's lifetime, the value associated with the proximity will be lower than if the current date is only one day away from the projected end date. Furthermore, the maximum value associated with the proximity may occur when the current date is equal to the projected end date of the first product's lifetime.

Similarly, by determining when a product is likely to be purchased, the system can also determine when a product is not likely to be purchased. Therefore, the system can exclude advertisements for a particular product when a particular person has a low likelihood of considering, needing or purchasing the advertised product. Instead, the system may substitute or replace the advertisement for another advertisement for a product which the person may be more likely to purchase.

In some embodiments, a method for targeting an advertisement to a user may comprise retrieving a purchase history for a first product, determining whether the first product is related to a second product, wherein the second product is used subsequently to the first product, generating a lifetime for the first product, determining whether the current date is outside the lifetime of the first product, and if the current date is outside the lifetime of the first product, present an advertisement for the second product.

In some embodiments, a method for targeting an advertisement to a user may comprise transmitting, from a server, a query for first purchase history information and first product information, wherein the query comprises a first product identifier for a first product and a user identifier; receiving a plurality of data packets comprising the first product information and the first purchase history information in response to the query; computing, using control circuitry, a relationship metric between the first product information and second product information for a second product; determining whether the first product and second product are related based on the computed relationship metric; automatically processing the first product information and the first purchase history information to compute a lifetime for the first product when the first product and the second product are related; comparing, using control circuitry, a current date and the lifetime of the first product to determine whether the current date is outside the lifetime of the first product; and generating, using control circuitry, an instruction for presenting an advertisement for the second product on a device when the current date is outside the lifetime of the first product.

In some embodiments, the first product information comprises a user profile. In some embodiments, the lifetime begins when the user purchases the first product. In some embodiments, the lifetime begins when the user initially used the first product. In some embodiments, the method further comprises computing an end date of the lifetime and determining the proximity of the current date to the end date of the lifetime.

In some embodiments, computing the relationship metric between the first product information and the second product information for a second product comprises comparing data fields in the first product information to data fields in the second product information. In some embodiments, computing the relationship metric between the first product information and the second product information for a second product comprises comparing words in a product description field in the first product information to words in a product description field in the second product information.

In some embodiments, the lifetime of the first product ends at a predetermined time when the user is likely to want the second product. In some embodiments, the method further comprises scheduling the advertisement to be presented to the user after the end of the lifetime of the first product, if the current date is within the lifetime of the first product. In some embodiments, the method further comprises excluding the advertisement after a predetermined amount of time after the end of the lifetime of the first product.

In some embodiments, the method further comprises selecting an advertisement for a third product, wherein the third product is intended to be used subsequently to a fourth product. In some embodiments, the lifetime of the first product ends at a predetermined time when the user is likely to want the second product.

In some embodiments, the method further comprises determining an end date of the lifetime and determining the proximity of the current date to the end date of the lifetime. In some embodiments, the method further comprises determining a rating for the advertisement and excluding the advertisement if the rating is below a threshold.

It should be noted, the systems and/or methods described above may be applied to, or used in accordance with, other systems, methods and/or apparatuses.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative media listing display that may be used to provide advertisements in accordance with some embodiments of the disclosure;

FIG. 2 shows another illustrative media listing display that may be used to provide advertisements in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5A is a flowchart of illustrative steps involved in providing advertisements in a media system in accordance with some embodiments of the disclosure;

FIG. 5B is a flowchart of illustrative steps involved in providing advertisements in a media system in accordance with some embodiments of the disclosure;

FIG. 6A is a flowchart of illustrative steps involved in providing advertisements in a media system in accordance with some embodiments of the disclosure, further describing determining a user's product's lifetime, beginning date and end date;

FIG. 6B is a flowchart of illustrative steps involved in providing advertisements in a media system in accordance with some embodiments of the disclosure, further describing determining whether a first product is related to a second product;

FIG. 7A is a timeline illustrating results involved in providing advertisements in a media system in accordance with some embodiments of the disclosure;

FIG. 7B is a timeline illustrating results involved in providing advertisements in a media system in accordance with some embodiments of the disclosure;

FIG. 8 is a flowchart of illustrative steps involved in selecting advertisements from multiple advertisements in a media system in accordance with some embodiments of the disclosure;

FIG. 9 is a graph illustrative of determining a value associated with the proximity of the current date to the end of a user's product's lifetime;

FIG. 10A is a timeline illustrating results involved in providing advertisements in a media system in accordance with some embodiments of the disclosure;

FIG. 10B is a timeline illustrating results involved in providing advertisements in a media system in accordance with some embodiments of the disclosure;

FIG. 10C is a timeline illustrating results involved in providing advertisements in a media system in accordance with some embodiments of the disclosure; and

FIG. 11 is a flowchart of illustrative steps involved in selecting advertisements from multiple advertisements in a media system in accordance with some embodiments of the disclosure.

### DETAILED DESCRIPTION

Targeted advertising is a type of advertising whereby advertisements are placed so as to reach consumers based on various traits such as demographics, purchase history, and/or observed behavior. Targeting advertisements is described in greater detail in U.S. Pat. No. 6,177,931, to Alexander et al., issued Jan. 23, 2001, which is hereby incorporated by reference in its entirety. Throughout this disclosure any of these traits or a combination of these traits and other information may be used in any embodiment when targeting an advertisement.

An advertisement may be targeted based on a user's age, gender, income level, race and ethnicity. In addition, an advertisement may be targeted based on particular products that were purchased, not purchased, advertised but not purchased, purchased but not advertised, purchased in a series, not purchased in a series, purchased individually, not purchased individually, purchased with particular other products, not purchased with particular other products, or any other feasible method or combination of multiple methods.

An advertisement may also be targeted based on any other observed behavior. Behavior may be observed through any suitable means, or combination of, including but not limited to, purchase histories, which may include user transaction histories and order histories, market research, industry reports, customer accounts, credit card information, surveys, interviews, receipt collection, UPC code scans, order tracking, deliver schedules, gift registries, and buying habits. Any of these methods may be performed or received by advertisers, retailers, customers, users, or any other person, party or group, and may be performed or received in person, over the telephone, on-line, over the radio, through the mail, through text messaging, through print media, through social media, over the Internet, via a network, or by any other suitable method or combination of multiple methods.

The behavior observed may be of a single person, user or group, or multiple people, users or groups. User can refer to any of the aforementioned, and will be used interchangeably throughout this disclosure. Furthermore, a user may encompass any person or thing that uses or relates to a product directly or indirectly. Moreover, multiple types of observations of a user or multiple users may be combined, derived or adjusted for the purposes of this disclosure.

Throughout this disclosure an advertisement may refer to anything used to promote, whether in a positive or negative light, products, goods, brands, services, events, actions, decisions, people, corporations, or political groups. Furthermore, throughout this disclosure, it should be understood that the term “product” when used in relation to something being promoted by an advertisement may be interchangeable with service or any of the things listed in this paragraph. For example, when some embodiments of this disclosure state that an advertisement is for a product, one of ordinary skill in the art would understand that the embodiments could be applied to an advertisement for a service, good, brand, etc.

Furthermore, any information used when targeting an advertisement may be used to developing a user or product profile. A user profile is a collection of data about a user. For example, a user profile may contain the age, gender, income level, race and/or ethnicity of the user. A product profile is a collection of data about a product. For example, a product profile may describe when, how and for what length of time a product may be used. In addition, a product profile may be used to determine the lifetime of a product, the beginning of the lifetime of the product, and/or the end of the lifetime of the product.

The user profile may also be used with a product profile to determine the lifetime of a product, the beginning of the lifetime of the product, and/or the end of the lifetime of the product. For example, the lifetime of a particular product may depend, at least in part, on the particular user associated with that product.

In some embodiments, the lifetime of a particular product may be based solely on the product profile. For example, the system may not have information about the user that bought a washing machine, but the system may determine the typical washing machine's product lifetime is ten years. Therefore, the product lifetime of the washing machine may be a default or predetermined product lifetime.

In some embodiments, the lifetime of a particular product may be based on the combination of the user profile and the product profile. For example, the typical product lifetime of a washing machine may be ten years, but the user profile of the purchaser may indicate the washing machine will not be used often, extending the product lifetime of the washing machine to twenty years.

The user or product profile may be based on observed behavior of the user and/or use of the product. Behavior may be observed through any suitable means, or combination of, including but not limited to, collecting data regarding purchase histories, which may include user transaction histories and order histories, market research, industry reports, customer accounts, credit card information, surveys, interviews, receipt collection, UPC code scans, order tracking, deliver schedules, gift registries, and buying habits. Any of these observations, or the underlying data, may be performed, obtained and/or received by advertisers, retailers, customers, users, or any other person, party or group, and may be performed or received in person, over the telephone, on-line, over the radio, through the mail, through text messaging, through print media, through social media, over the Internet, via a network, or by any other suitable method or combination of multiple methods.

For example, data collected (e.g., purchase histories, market research, etc.) may be obtained from a single source (e.g., a website that stores a user's prior purchases on the site) or from multiple sources (e.g., a service that retrieves data such as prior purchases from several third party sources or sites).

The behavior used to generate a user or product profile may be of a single person, user or group, or multiple people, users or groups. User can refer to any of the aforementioned, and will be used interchangeably throughout this disclosure when describing a user or product profile. Furthermore, a user may encompass any person or thing that uses or relates to a product directly or indirectly. Moreover, multiple types of observations of a user or multiple users may be combined, derived or adjusted for the purposes of this disclosure.

Furthermore, throughout this disclosure observed behavior, and any of the observation methods described above, may be used to determine when a user obtains, purchases, receives, uses, or any other relevant action related to a product, or a product related to another product. For example, a user purchase history may be used to determine when a user purchased an item, and the purchase history may have been obtained by a retailer during a prior purchase.

In some embodiments, user profiles, product profiles and/or observed behavior may be used to determine whether or not products are related, a user's product's lifetime beginning date, a user's product's lifetime end date and/or a user's product's lifetime, all of which may be used to determine whether or not an advertisement should be shown at a particular time.

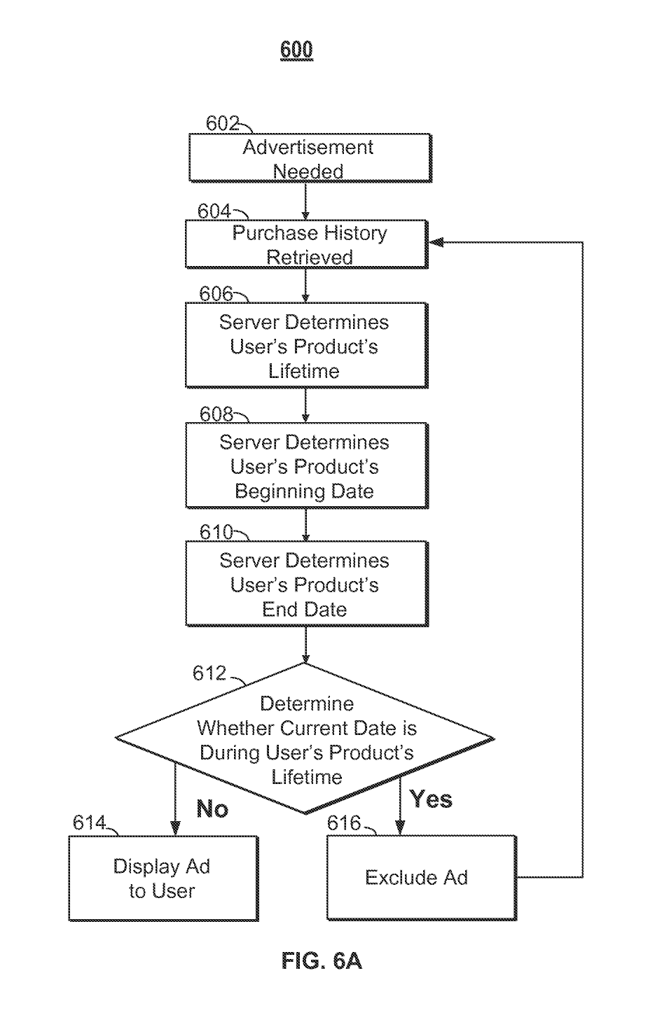

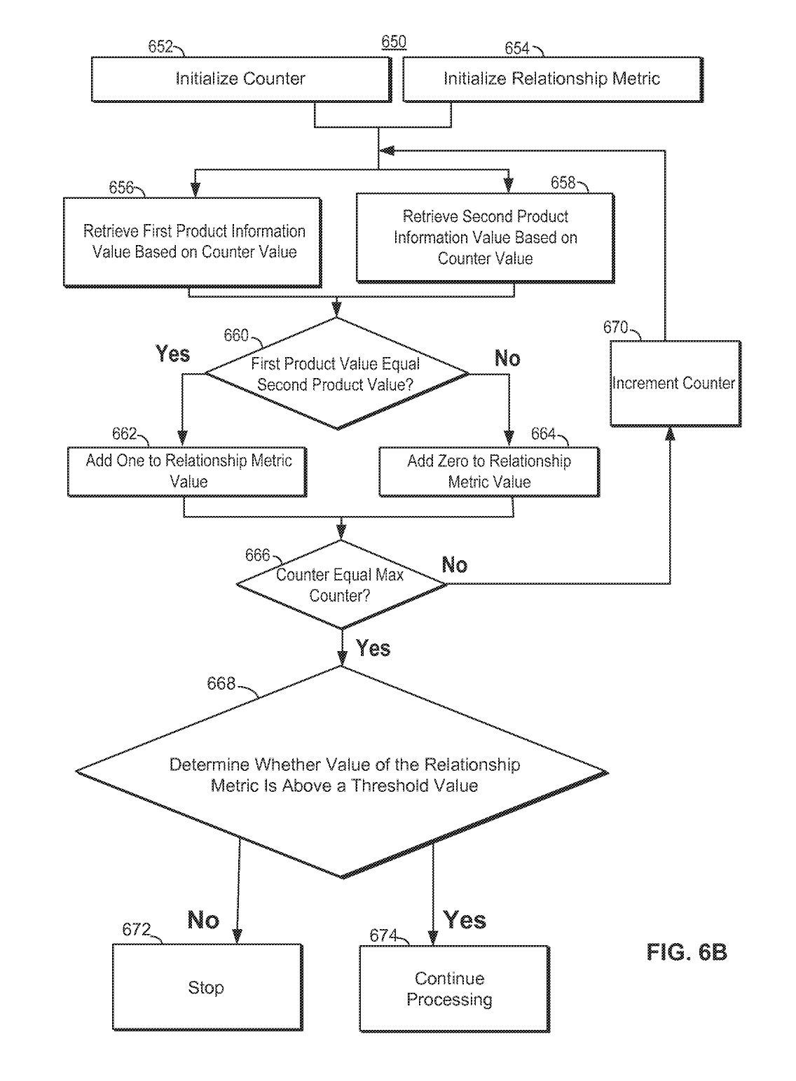

To determine the appropriate time at which to target an advertisement, the system may need to first determine what product is related to the advertised product. Related products are products where the purchase, possession, and/or use or one product affects the purchase, possession, and/or use of the other products. Systems and methods for determining whether or not one product is related to another product may use a relationship metric as discussed in detail in relation to FIG. 6B. For example, a first movie of a movie trilogy may be related to the second movie in a movie trilogy because the movies in a trilogy are typically watched in series. In another example, a car may be related to another car because a user may only be likely to have one car at any point in time; therefore, the user may not be likely to purchase a second car.

The system may determine whether or not two products are based on observed behavior regarding the two products or similarities in the product profiles, and may store information on whether on not two products are related.

Once the system has determined a first product is related to a second product, the system may then determine the lifetime of a product. The lifetime of a product is the amount of time a particular product is used by a user before the user begins to want or need a related product.

The system may also determine the beginning of the product lifetime of the product. In some embodiments, the product lifetime begins when a user purchases, obtains, or initially uses a product. For example, a product lifetime may begin when a user purchases a book. In another example, a product lifetime may begin when a user is given a book. In some embodiments, a product lifetime may begin when a user initially uses a product. For example, a user may purchase an e-book or movie from a website; however, the user may not watch the movie or read the e-book for a particular period of time. The website may track when the user begins watching the movie or reading the e-book, and select this point as the beginning date of the product lifetime. In some embodiments, the product lifetime begins when a product is created. For example, some products such as food may be perishable.

In some embodiments, the product lifetime may further depend on the particular user. For example, while a monthly subscription may end at the same time for all users, some products or services may depend on the frequency or usage of the particular user. For example, while two users may purchase the same book on the same day, it will likely take the two users different amounts of time to read the book. Furthermore, one of the users may wish to read the book a second time before buying a new book. Therefore, the system may need to develop a profile associated with particular users or groups of users. For example, by tracking a user's purchasing habits, the system may determine that the user purchases a new video game every month. Based on this habit, the system may determine that the product lifetime of a video game purchased by a user is one month.

After determining when the product lifetime began and the length of the product lifetime based on the particular user, the system can determine the end of the product lifetime. The end of the product lifetime refers to the time when the user is likely to obtain or consider obtaining an advertised product related to the previously obtained product. For example, at some point after obtaining a particular product, a user may decide that the particular product has become outdated, inoperable, completely/sufficiently used or no longer sufficient for its intended purpose, and the user may begin looking for a new or replacement product.

By determining when a particular product's lifetime begins and adding the lifetime of the product, the system may determine when a user may need or may be looking to purchase a new or related product. By targeting advertisements for the product to the particular person at this particular time, the system can increase the likelihood that the person will purchase the product.

Similarly, by determining when a product is likely to be purchased, the system can also determine when a product is not likely to be purchased. Therefore, the system can exclude advertisements for a particular product when a particular user has a low likelihood of considering, needing or purchasing the advertised product. Instead, the system may substitute or replace the advertisement for another advertisement for which the user may be more likely to purchase.

For example, the system may determine a customer recently obtained a three-year lease on a car. Therefore, the system may refrain from advertising cars to the particular customer until later in the lease period when a customer may be interested in obtaining a new car, such as a few months before the lease expires. Instead, the system may advertise a service related to the car.

In another example, the system may determine that a person recently received a home appliance as a wedding present. The system may determine that the average operation lifetime of the home appliance for the user is ten years. The system may then refrain from advertising a similar home appliance until the person is likely to need a replacement, such as ten years from the wedding. Similarly, the system may determine the person obtained a two year warranty for the home appliance. The system may want to refrain from advertising a service contract for the home appliance until near the end of the warranty. Instead, the system may advertise items to use with the appliance.

In another example, the system may determine that a customer recently purchased a DVD containing the first season of a television show. The system may also determine that typical length of time that the customer takes to watch a season of television. The system may then refrain from advertising the next season of the particular show until a time when the customer may be interested in purchasing the second season, such as near the end of the first season's lifetime when the customer has almost completed watching the first season. Instead, the system may advertise a DVD of a different television show.

In some embodiments, an advertisement may be excluded after the user previously interacts with a product related to an advertised product, an advertisement for the product related to an advertised product, and/or the advertisement for the advertised product. For example, the system may prevent an advertisement for a shoe from being shown to a user where the same advertisement was previously shown and/or interacted with by the user. In another example, the system may prevent an advertisement for a shoe related to the previously advertised shoe.

In some embodiments, the system may exclude advertisement when the system determines that the advertisement is for a product that a user would not purchase again. Instead, the system may consider other advertisements for products that the user might purchase again, subsequently and/or in series. For example, the system may not present an advertisement for a book the user has already purchased, but the system may advertise a different book of the same genre or in the same series as the purchased book.

The amount of content available to users in any given content delivery system can be substantial. Consequently, many users desire a form of media guidance through an interface that allows users to efficiently navigate content selections and easily identify content that they may desire. Furthermore, advertisements may be displayed before, after or during content. In addition, the advertisements of this disclosure may relate to displayed content. An application that provides such guidance is referred to herein as an interactive media guidance application or, sometimes, a media guidance application or a guidance application. An interactive media guidance application may also be used to deliver the targeted advertisements of this disclosure.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content. Interactive media guidance applications may generate graphical user interface screens that enable a user to navigate among, locate and select content. As referred to herein, the term “content” may mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content or advertisements described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a website), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

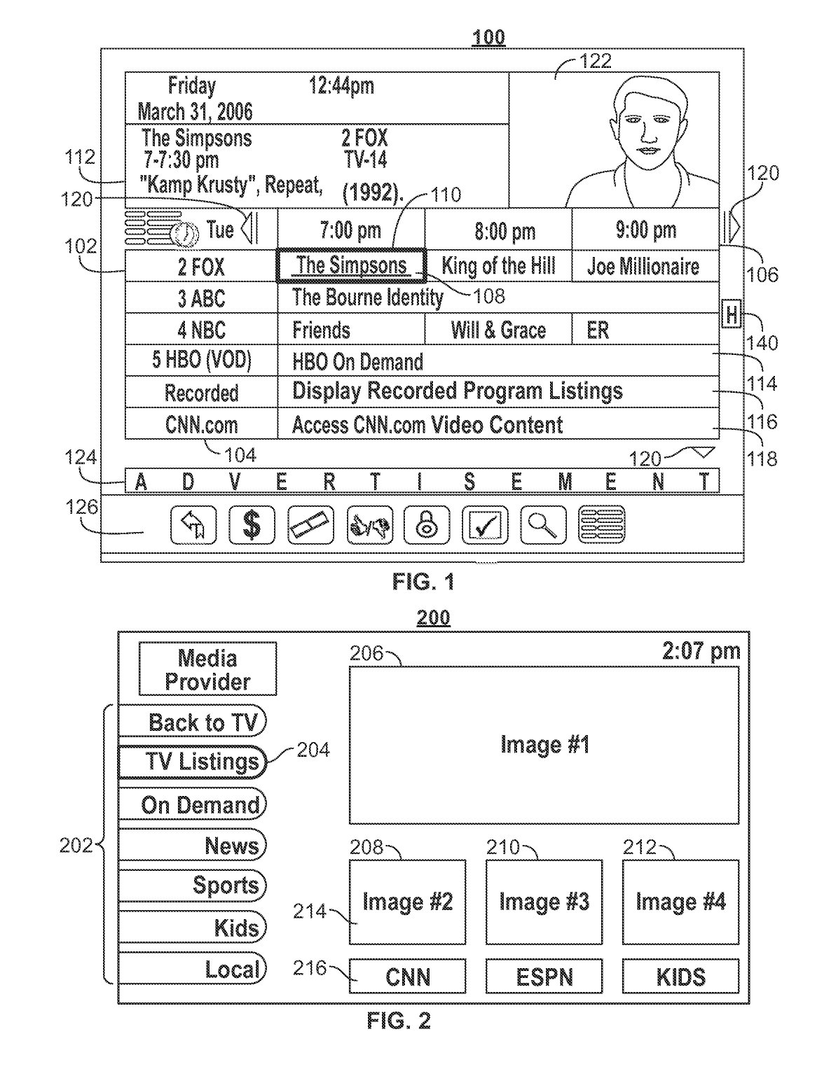

FIGS. 1-2 show illustrative display screens that may be used to provide media guidance data, content and/or advertisements. The display screens shown in FIGS. 1-2 and may be implemented on any suitable user equipment device or platform. While the displays of FIGS. 1-2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g., FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

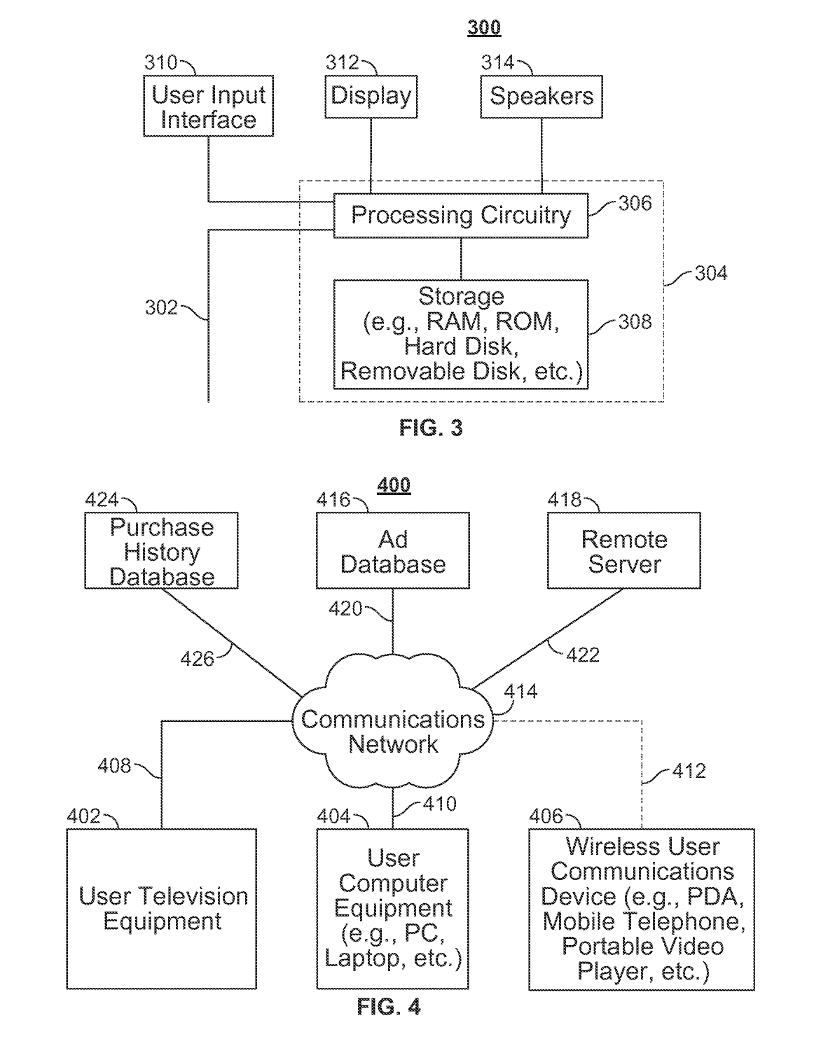

Users may access content, advertisements, and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter, “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above-mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which are described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including, for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in network system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a stand-alone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some user television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes purchase history database 424, advertisement database 416, and remote server 418 coupled to communications network 414 via communication paths 426, 420 and 422, respectively. Paths 426, 420 and 422 may include any of the communication paths described above in connection with paths 408, 410, and 412. Communications with the purchase history database 424, advertisement database 416 and remote server 418 may be exchanged over one or more communications paths, but are shown as a single path in FIG. 4 to avoid overcomplicating the drawing. In addition, there may be more than one of each of purchase history database 424, advertisement database 416 and remote server 418, but only one of each is shown in FIG. 4 to avoid overcomplicating the drawing. (The different types of each of these sources are discussed below.) If desired, purchase history database 424, advertisement database 416 and remote server 418 may be integrated as one source device. Although the connection of purchase history database 424, advertisement database 416 and remote server 418 with user equipment devices 402, 404, and 406 are shown is shown through communications network 414, in some embodiments, advertisement database 416, remote server 418 and purchase history database 424 may communicate directly with user equipment devices 402, 404, and 406 via communication paths (not shown) such as those described above in connection with paths 408, 410, and 412.

Advertisement database 416 may be a database, or one or more types of content distribution equipment, including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Advertisement database 416 may be the originator of content (e.g., a television broadcaster, a Webcast provider, etc.) or may not be the originator of content (e.g., an on-demand content provider, an Internet provider of content of broadcast programs for downloading, etc.). Advertisement database 416 may include cable sources, satellite providers, on-demand providers, Internet providers, over-the-top content providers, or other providers of content. Advertisement database 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Remote server 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, remote server 418 may be configured to transmit a query (e.g., to the purchase history database 424) for first purchase history information and first product information, wherein the query comprises a first product identifier for a first product and a user identifier. The remote server 418 may be configured to receive a plurality of data packets comprising the first product information and the first purchase history information in response to the query. The remote server 418 may be configured to compute, using control circuitry, a relationship metric between the first product information and second product information for a second product. The remote server 418 may be configured to determine whether the first product and second product are related based on the computed relationship metric.

The remote server 418 may be configured to automatically process the first product information and the first purchase history information to compute a lifetime for the first product when the first product and the second product are related. The remote server 418 may be configured to compare, using control circuitry, a current date and the lifetime of the first product to determine whether the current date is outside the lifetime of the first product. The remote server 418 may be configured to generate, using control circuitry, an instruction for presenting an advertisement for the second product on a device when the current date is outside the lifetime of the first product.

Purchase history database 424 may comprise any of the user profile, product profile or advertisement data associated with a particular user. Purchase history database 424 may also include any of the behavioral observation data discussed above. Purchase history database 424 may comprise any data structure (e.g., ordered/unordered flat files, hash tables, B+ trees, ISAM, and/or heaps) for storing the user profile data, product profile data, advertisement data and/or behavioral observations data. In addition, purchase history database 424 may use any database management system. The data in purchase history database 424 may use any standard encoding (e.g., ASCII).

In some embodiments, the purchase history database 424 be configured to receive a request for a purchase history for a first product. The purchase history database 424 may be configured to determine the type of data request (e.g., purchase history, product profile, etc.). In addition, the purchase history database 424 may be configured to process the data request and retrieve data. The retrieved data may be transmitted in data packets and may correspond to particular data fields. Furthermore, the purchase history database 424 may be configured to indentify sections of data (e.g., header, payloads, etc.), flags or identifiers (e.g., indicating attributes about the data), as well as requested content.

The purchase history database 424 may then process the retrieved data and generate a response. The response may be transmitted in data packets and adapted and/or formatted for the receiving device.

In some embodiments, guidance data, user profile data, product profile data, advertisement data and/or behavioral observations data from remote server 418 or purchase history database 424 may be provided to users' equipment using a client-server approach. For example, a user equipment device may pull media guidance data, user profile data, product profile data, advertisement data and/or behavioral observations data from a server, or a server may push media guidance data to a user equipment device. In some embodiments, a guidance application client residing on the user's equipment may initiate sessions with remote server 418 and/or purchase history database 424 to obtain guidance data, user profile data, product profile data, advertisement data and/or behavioral observations data when needed, e.g., when the guidance data, user profile data, product profile data, advertisement data and/or behavioral observations data is out of date or when the user equipment device receives a request from the user to receive data. Media guidance, user profile data, product profile data, advertisement data and/or behavioral observations data may be provided to the user equipment with any suitable frequency (e.g., continuously, daily, a user-specified period of time, a system-specified period of time, in response to a request from user equipment, etc.). Remote server 418 and/or purchase history database 424 may provide user equipment devices 402, 404, and 406 the media guidance, user profile, product profile, advertisement and/or behavioral observations application itself or software updates for the media guidance application.

Media guidance, user profile, product profile, advertisement and/or behavioral observations applications may be, for example, stand-alone applications implemented on user equipment devices. For example, the media guidance, user profile, product profile, advertisement and/or behavioral observations applications may be implemented as software or a set of executable instructions which may be stored in storage 308, and executed by control circuitry 304 of a user equipment device 300.

In some embodiments, media guidance, user profile, product profile, advertisement and/or behavioral observations applications may be client-server applications where only a client application resides on the user equipment device, and server application resides on a remote server. For example, media guidance, user profile, product profile, advertisement and/or behavioral observations applications may be implemented partially as a client application on control circuitry 304 of user equipment device 300 and partially on a remote server as a server application (e.g., remote server 418 and/or purchase history database 424) running on control circuitry of the remote server.

When executed by control circuitry of the remote server (such as remote server 418), the media guidance application may instruct the control circuitry to generate the guidance application displays and transmit the generated displays to the user equipment devices. The server application may instruct the control circuitry of the remote server 418 to transmit data for storage on the user equipment. The client application may instruct control circuitry of the receiving user equipment to generate the guidance application displays.

Content, media guidance, user profile, product profile, advertisement and/or behavioral observations data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content, media guidance, user profile, product profile, advertisement and/or behavioral observations data, providers of OTT content can distribute content, media guidance, user profile, product profile, advertisement and/or behavioral observations applications (e.g., web-based applications or cloud-based applications), or the content, media guidance, user profile, product profile, advertisement and/or behavioral observations applications stored on the user equipment device.

Network system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, are discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with advertisement database 416, purchase history database 424, or remote server 418 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more advertisement databases 416, one or more remote servers 418, and one or more purchase history databases 424. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

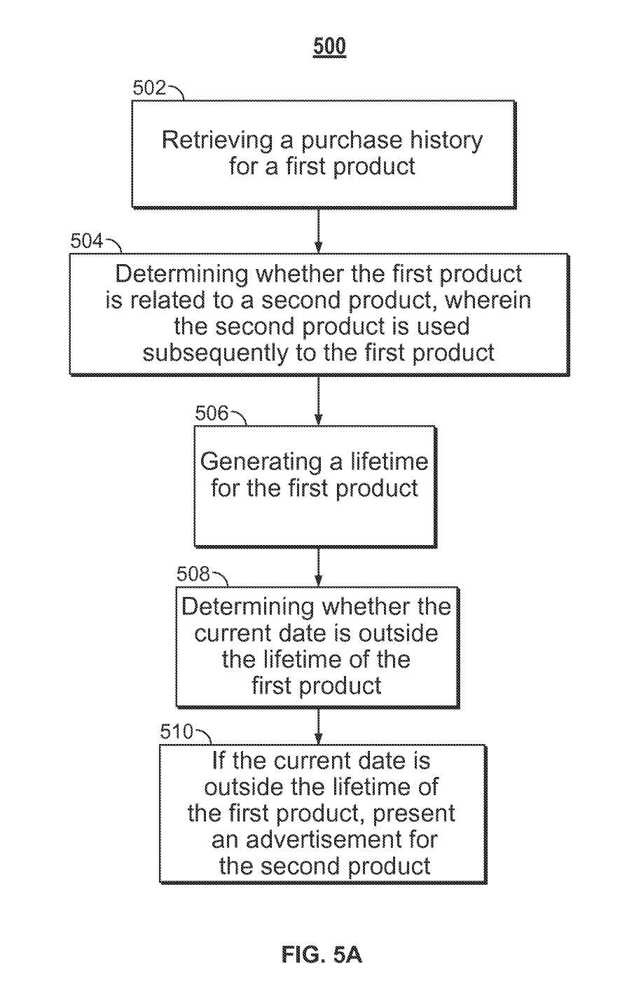

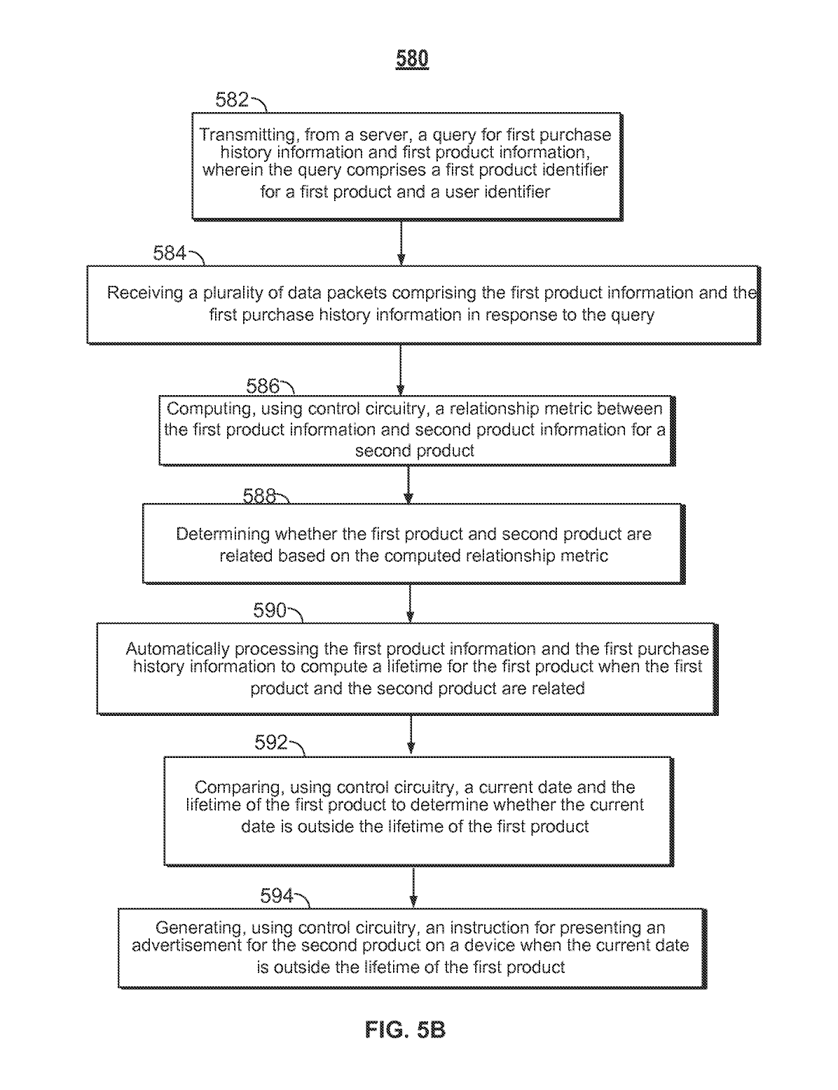

FIGS. 5-11 disclose some embodiments of the disclosure. Any step or any result may be obtained by using any of the devices and objects shown or described in FIGS. 1-4. Furthermore, any step or embodiment related to FIGS. 5-11, or any other step or embodiment disclosed in this embodiment may be applied to multiple advertisements, either substantially in series or substantially in parallel. For example, it may be more efficient to perform several steps of an embodiment on multiple advertisements or products, before performing the remaining steps of the embodiment on any one of the advertisements or products.

FIG. 5A is a flowchart of illustrative steps involved in providing advertisements in media system in accordance with an embodiment of the disclosure. The media system analyzes a user's prior purchases for products that may be related to an advertised product. By combining the prior purchase information with a user profile and/or product profile, the media system can further determine a product lifetime for the prior purchased product. Based on this lifetime, the system may determine when to present an advertisement for a product related to the prior purchased product.

At step 502 of flowchart 500, the system retrieves a purchase history for a first product. The purchase history may be associated with a particular account or a set of multiple accounts for a user or group. For example, the purchase history may be for all transactions made by the user on a particular website.

The advertisement database 416 (FIG. 4), remote server 418 (FIG. 4), purchase history database 424 (FIG. 4), user equipment 402, 404, and/or 406 (FIG. 4), and/or any device accessible via the communications network 414 (FIG. 4) may perform this step. Furthermore, the purchase history may be located on purchase history database 424 (FIG. 4) and/or any device accessible via the communications network 414 (FIG. 4). For example, the purchase history may be located at a particular website, which tracks the user's prior purchases at the website.

At step 504, the system determines whether the first product is related to a second product, wherein the second product is used subsequently to the first product. For example, the first and second product may be Blu-ray disc of the first and second seasons of a particular television show; therefore, the system may determine a user is likely to purchase both. In addition, a user is unlikely to watch the second season first, so the purchase of the first season indicates that a user may at some later point purchase the Blu-ray disc of the second season. In another example, the first product may be related to a second product because both products are video games of the same genre. The user may be unlikely to use two video games at the same time, so the games are bought and used in series.

The advertisement database 416 (FIG. 4), remote server 418 (FIG. 4), purchase history database 424 (FIG. 4), user equipment 402, 404, and/or 406 (FIG. 4), and/or any device accessible via the communications network 414 (FIG. 4) may perform this step. Additional information and product analysis to determine whether or not a product is related to another product may be stored and accessed through the purchase history database 424 (FIG. 4) or any other device accessible via communications network 414 (FIG. 4).

At step 506, the system generates a lifetime for the first product. This profile may be based on the user. For example, the system may use a user's profile to determine how long a user may use a particular product, if the user has particular buying habits or cycles, or the length of time until a user buys another product, which may be different than the typical buyer of these products. The system may also use a combination of factors, including, but not limited to, the weighting system described in relation to FIG. 6A below.

The advertisement database 416 (FIG. 4), remote server 418 (FIG. 4), purchase history database 424 (FIG. 4), user equipment 402, 404, and/or 406 (FIG. 4), and/or any device accessible via the communications network 414 (FIG. 4) may perform this step.

At step 508, the system determines whether the current date is outside the lifetime of the first product. The system may determine the current date or time through any suitable means, such as internal or external clocks or calendars. The system may then compare the current date with the lifetime of the first product. For example, the lifetime of the first product may begin on December 1^{st} and end on December 31st, and the system would determine if the current date is in the month of December.

The advertisement database 416 (FIG. 4), remote server 418 (FIG. 4), purchase history database 424 (FIG. 4), user equipment 402, 404, and/or 406 (FIG. 4), and/or any device accessible via the communications network 414 (FIG. 4) may perform this step or may perform this step.

At step 510, the system presents an advertisement for the second product to the user, if the current date is outside the lifetime of the first product. For example, if a user bought a book on the first of March and the lifetime of the book is one month, the system may present the advertisement if the current date is during April. As discussed below, the presentation of a particular advertisement may be restricted to a certain time period or restricted based on the attributes of other advertisements.

The advertisement database 416 (FIG. 4), remote server 418 (FIG. 4), purchase history database 424 (FIG. 4), user equipment 402, 404, and/or 406 (FIG. 4), and/or any device accessible via the communications network 414 (FIG. 4) may perform this step.

It is contemplated that the steps or descriptions of FIG. 5A may be used with any other embodiment of this disclosure. In addition, the steps and descriptions described in relation to FIG. 5A may be done in alternative orders or in parallel to further the purposes of this disclosure. For example, each of these steps may be performed in any order or in parallel or substantially simultaneously to reduce lag or increase the speed of the system or method.

FIG. 5B is a flowchart of illustrative steps involved in providing advertisements in media system in accordance with an embodiment of the disclosure. The media system analyzes a user's prior purchases for products that may be related to an advertised product. By combining the prior purchase history information and product information, the system can determine a relationship metric used to determine a user profile and/or product profile, the media system can further determine a product lifetime for the prior purchased product. Based on this lifetime, the system may determine when to present an advertisement for a product related to the prior purchased product.

At step 582, process 580 transmits a query for purchase history information and product information. For example, the server may request information from other servers or third party devices to determine whether or not a particular product was purchased, and if it was, may also retrieve information on the person that purchased the product and when the person purchased the product. Therefore, in order to obtain the required information, the query may comprise a first product identifier for the product and a user identifier for the user.

At step 584, process 580 receives a plurality of data packets comprising the first product information and the first purchase history information in response to the query. In some embodiments, the product information may comprise a plurality of data fields used to describe the product. For example, the data fields may comprise textual descriptions of the products or may comprise values associated with specific attributes or traits of the product. In some embodiments, the product information may also comprise a plurality of data fields to describe the user. For example, the data fields may include values associated with specific demographics, or the values may relate to how the particular user interacts with a product (e.g., how long the user typically uses the product).

In some embodiments, the purchase history information may comprise a plurality of data fields used to describe the purchase. The data fields may comprise textual descriptions of the purchase or may comprise values associated with specific characteristics of the purchase. For example, the data fields may include values associated information regarding when, how, or for whom, the product was purchased (e.g., whether or not the product was purchased off from a gift registry as a gift).

At step 586, process 580 computes, using control circuitry, a relationship metric between the first product information and second product information for a second product. For example, the server may compare corresponding data fields for the first product information and the second product information. Upon determining that one or more values of the corresponding data fields are equal, the server may determine that the two products are related. In another example, the server may analyze particular data fields of the first product information and the second product information for particular values or text (e.g., searching for keywords in a textual description field). The computation of the relationship metric will be discussed in depth in regard to FIG. 6B.

At step 588, process 580 determines whether the first product and second product are related based on the computed relationship metric. In some embodiments, process 580 may assign a value to the comparison of step 586. The server may use the computed relationship metric value to determine whether the first product and the second product are related. For example, the server may compare the value of the relationship metric found in step 586 to a threshold value. Upon finding a particular value, the server may determine that the two products are related.

At step 590, process 580 automatically processes the first product information and the first purchase history information to compute a lifetime for the first product when the first product and the second product are related. In some embodiments, the system may automatically process the first product information and the first purchase history information to compute a lifetime for the first product when the first product and the second product are related. For example, in response to determining that two products are related, the system may analyze the purchase history data for the first product to determine when the first product lifetime began. The system may then use the first product information to determine the duration of that lifetime.

In some embodiments, once the system has determined whether or not one product is related to another product, the system can then determine the lifetime of that product or service. In some embodiments, the product or service lifetime will further depend on the particular user. In some embodiments, to compensate for the variability in product lifetimes resulting from different users, the system may compute the lifetime of the product using, for example, a weighted arithmetic mean. The system may retrieve user profile information comprising time variables and associated weight values from within the data fields of the first product information. Alternatively, the user profile may be extracted separately from the first product profile information.

By analyzing the purchase history information data fields, the system can determine when a particular product was purchased or initially used. By retrieving the sum of the purchase date and computed product lifetime, the system can determine when a user may need or may be looking to purchase a new or related product. Therefore, the system can increase the likelihood that the person will purchase the product by targeting advertisements for the product to the particular person at this particular time.

At step 592, process 580 compares, using control circuitry, a current date and the lifetime of the first product to determine whether the current date is outside the lifetime of the first product. In some embodiments, the system may compare the current date and the sum of the lifetime of the first product to determine whether or not the current date is outside the lifetime of the first product. In response to this determination, the system may generate an instruction for presenting an advertisement for the second product on a device. In some embodiments, determining whether or not the current date is outside the first product's lifetime may include comparing a value to a particular threshold. For example, the system may use the sum to generate a value for the proximity of the current date to the date of the sum.

In some embodiments, the system may apply statistical methods (e.g., adjusting for standard deviations in a normal distribution), to compute the value associated with the proximity of the current date to the projected end date of the first product's lifetime. For example, if the current date is three days away from the projected end date of the first product's lifetime, the value associated with the proximity will be lower than if the current date is only one day away from the projected end date. Furthermore, the maximum value associated with the proximity may occur when the current date is equal to the projected end date of the first product's lifetime.

At step 594 process 580 generates, using control circuitry, an instruction for presenting an advertisement for the second product on a device when the current date is outside the lifetime of the first product. The instruction may be transmitted in any suitable form (e.g., data packets), which may be received by any of the forms of data transmission discussed in relation to FIG. 4 above. The instruction may be transmitted substantially instanteuously over the communications network 414 (FIG. 4). In some embodiments, the instruction may be sent to a user device or display (e.g., a smartphone or television), or the instruction may be sent to another server, which provides advertisements to a user device or display. For example, an instruction generated by process 580 may instruct advertisement database 416 (FIG. 4) or remote server 418 (FIG. 4) to display an advertisement on user equipment 402, 404, and/or 406 (FIG. 4) and/or any device accessible via the communications network 414 (FIG. 4).

It is contemplated that the steps or descriptions of FIG. 5B may be used with any other embodiment of this disclosure. In addition, the steps and descriptions described in relation to FIG. 5B may be done in alternative orders or in parallel to further the purposes of this disclosure. For example, each of these steps may be performed in any order or in parallel or substantially simultaneously to reduce lag or increase the speed of the system or method.

Any of the steps or embodiments described in relation to FIG. 5B may be performed by any of the devices shown in FIG. 4. For example, the advertisement database 416 (FIG. 4), remote server 418 (FIG. 4), purchase history database 424 (FIG. 4), user equipment 402, 404, and/or 406 (FIG. 4), and/or any device accessible via the communications network 414 (FIG. 4) may perform, or may combine to perform, any of the steps or embodiments described in relation to FIG. 5B.

FIG. 6A is a flowchart of illustrative steps involved in providing advertisements in a media system in accordance with some embodiments of the disclosure. By using any of the equipment described in relation to FIG. 4, the system determines a particular user's product's lifetime and when the lifetime begins. The system also determines when the lifetime ends (e.g., when a user may need or may be looking to purchase a new or related product). By targeting advertisements for the product to the particular person at this particular time, the system can increase the likelihood that the person will purchase the product.

In step 602 of process 600, the system may determine that an advertisement is needed. The advertisement may be part of any display discussed herein. For example, an advertisement may be needed to be displayed on a programming guide for a television, a web-page listing, or during a commercial interruption for broadcast or streaming media.

The advertisement database 416 (FIG. 4), remote server 418 (FIG. 4), purchase history database 424 (FIG. 4), user equipment 402, 404, and/or 406 (FIG. 4), and/or any device accessible via the communications network 414 (FIG. 4) may perform this step.

At step 604, the system retrieves a purchase history for a purchased product related to an advertised product. The system may determine that a purchased product is related to an advertised product via a user profile or product profile. The purchase history, user profile, and/or the product profile may be retrieved from the advertisement database 416 (FIG. 4), remote server 418 (FIG. 4), purchase history database 424 (FIG. 4), user equipment 402, 404, and/or 406 (FIG. 4), and/or any device accessible via the communications network 414 (FIG. 4). Furthermore, in some embodiments, the purchase history, user profile, and/or product profile may be combined or integrated.

At step 606, the system determines the user's product's lifetime of the purchased product. In some embodiments, a user's product's lifetime is calculated in accordance with a weighted lifetime function. In some embodiments, the lifetime function may take the form of:

$$Lifetime = \frac{{\sum }_{i = 1}^{N} {w}_{i} {t}_{i}}{{\sum }_{i = 1}^{N} {w}_{i}} \qquad ( EQ 1 )$$

where N is the total number of user criteria used to determine the user's product's lifetime, w is the weight assigned to the particular user criterion, and t is the time value within the criterion.

For example, a given lifetime calculation for a movie may have three factors (e.g., length of the particular movie, typical time between user purchases of movies in general, typical time between user purchases of movies of this genre), so that N is equal to three. The weight of each factor may be on a scale of one (being the lowest) to one-hundred (being the highest), so that the w associated with each of the three factors may be different. Finally, each factor may be given a time factor (e.g., three hours for the length of the particular movie, seventy-two hours for the typical time between user purchases of movies in general, and twenty-four hours for the typical time between user purchases of movies of this genre), so that t for each factor equals three, seventy-two, and twenty-four respectively. After the values are inputted into the weighted lifetime function, a user's product's lifetime is determined.

The variables, time values and weights selected may be determined based on the user profile, product file or observed behavior. For example, a user may buy two DVD sets, set A and set B. The lifetime of each DVD set may be defined as the time until the viewer has watched the entire play length. Each set may have the same play length (t₁) of fours hours; however, the weight associated (w₁) with set A and set B may be different. The genre of set A may be a thriller, where the user profile determines the user is likely to watch the entire play length of the DVD set in one sitting. In contrast, set B may be an episodic comedy, where the user profile determines the user is likely to break the play length into separate viewings. Therefore, (w₁) of set A may be higher than the (w₁) of set B because the actual play length better represents the lifetime of the product (e.g., the time until the user has completed the DVD set).

The advertisement database 416 (FIG. 4), remote server 418 (FIG. 4), purchase history database 424 (FIG. 4), user equipment 402, 404, and/or 406 (FIG. 4), and/or any device accessible via the communications network 414 (FIG. 4) may perform this step.

At step 608, the system determines the user's product's lifetime beginning date, D₁, for the purchased product. This may be determined by any of the behavioral observation methods discussed above. For example, the system may determine the user's product's lifetime beginning date by monitoring the user's on-line purchases. The system may determine that the first season of the DVD set was purchased by the user on the first day of April based on the account information of the user's on-line profile, and determine that for this particular DVD the purchase date is equal to the user's product's lifetime beginning date.

The advertisement database 416 (FIG. 4), remote server 418 (FIG. 4), purchase history database 424 (FIG. 4), user equipment 402, 404, and/or 406 (FIG. 4), and/or any device accessible via the communications network 414 (FIG. 4) may perform this step.

At step 610, the system determines the user's product's lifetime end date for the purchased product. This may be determined by any of the methods discussed above such as behavioral observation. For example, the system may determine that the subscription purchased by the user ends the last day of the current year; therefore, the last day of current year (or a date near that day) may represent the user's product's lifetime end date for the purchased product.

In some embodiments, the system determines the user's product's lifetime end date by adding the determined user's product's lifetime to the user's product's lifetime beginning date. For example, the system may determine that the first season of the DVD set was purchased by the user on a particular date based on user transaction histories and add the user's product's lifetime (calculated in days) to derive the user's product's lifetime end date.

For example, the system may determine the user's product's lifetime end date by adding the determined user's product's lifetime to the user's product's lifetime beginning date as shown:

Lifetime+D₁=μ (EQ 2)

In this example, μ represents the user's product's lifetime end date. It should be understood that various methods or algorithms could also be applied to embodiments of this disclosure.

The advertisement database 416 (FIG. 4), remote server 418 (FIG. 4), purchase history database 424 (FIG. 4), user equipment 402, 404, and/or 406 (FIG. 4), and/or any device accessible via the communications network 414 (FIG. 4) may perform step 610.

By establishing a beginning and end to the user's product's lifetime, the system may determine whether the current date, determined by any suitable means (e.g., an internal clock or calendar), falls within the span of the user's product's lifetime as shown in step 612. For example, the system may compare the current date to a standardized date and time.

The advertisement database 416 (FIG. 4), remote server 418 (FIG. 4), purchase history database 424 (FIG. 4), user equipment 402, 404, and/or 406 (FIG. 4), and/or any device accessible via the communications network 414 (FIG. 4) may perform step 612.

For example, if the DVD set of the first season had a lifetime of one week, and the user bought the DVD set of the first season on the first day of the week, the system would determine that the end date is not until the first day of the next week.

The advertisement database 416 (FIG. 4), remote server 418 (FIG. 4), purchase history database 424 (FIG. 4), user equipment 402, 404, and/or 406 (FIG. 4), and/or any device accessible via the communications network 414 (FIG. 4) may perform step 614.

If the current date is after the week, the system may display the advertisement as shown at step 614. If the current date is not after the week, the advertisement for a product related to the user's purchased product may be displayed to the user on user devices 402, 404, 406 (FIG. 4) or instructions to display the advertisement may be sent by advertisement database 416 (FIG. 4), remote server 418 (FIG. 4), purchase history database 424 (FIG. 4), user equipment 402, 404, and/or 406 (FIG. 4), and/or any device accessible via the communications network 414 (FIG. 4) may perform step 614.

If the current date is during the week, the system may exclude the advertisement as shown at step 616, and may return to step 604. The advertisement database 416 (FIG. 4), remote server 418 (FIG. 4), purchase history database 424 (FIG. 4), user equipment 402, 404, and/or 406 (FIG. 4), and/or any device accessible via the communications network 414 (FIG. 4) may perform step 616.

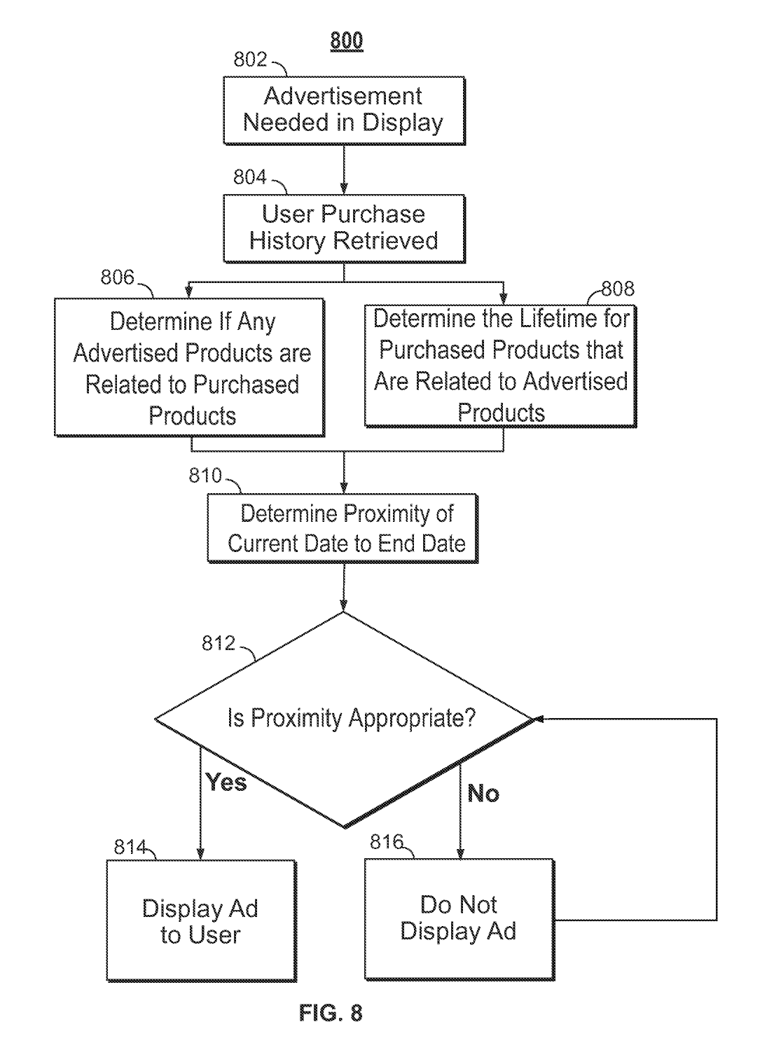

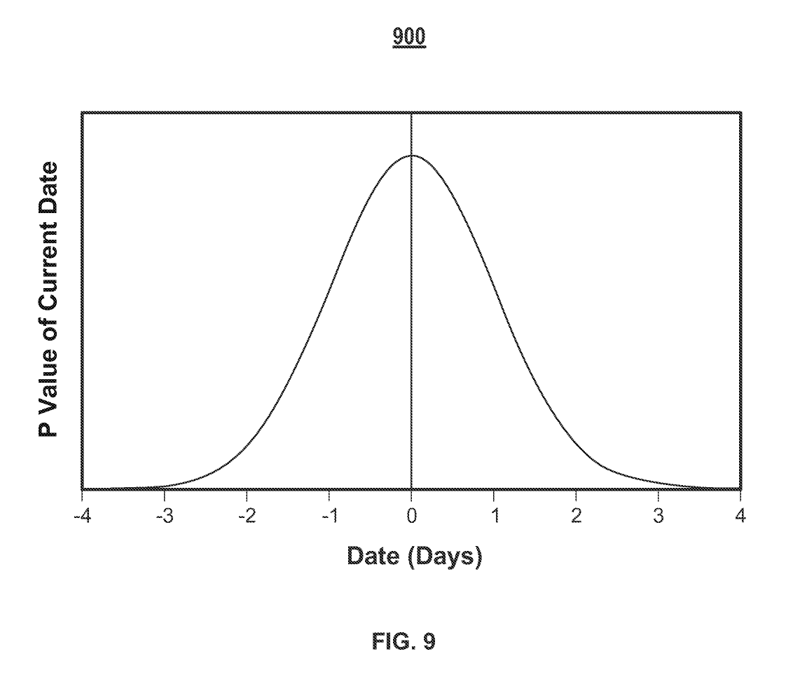

In some embodiments, the system may further target the time at which a particular advertisement is shown as discussed in more detail in relation to FIGS. 8 and 9. For example, instead of determining whether or not to exclude a particular advertisement, the system may rate available advertisements. Only advertisements with a certain rating (which may correspond to the time to display the advertisement) would be displayed. Alternatively, only the advertisement having the highest ratings of a set of advertisements would be displayed.

It is contemplated that the steps or descriptions of FIG. 6A may be used with any other embodiment of this disclosure. In addition, the steps and descriptions described in relation to FIG. 6A may be done in alternative orders or in parallel to further the purposes of this disclosure. For example, each of these steps may be performed in any order or in parallel or substantially simultaneously to reduce lag or increase the speed of the system or method.

FIG. 6B is a flowchart of illustrative steps involved in providing advertisements in a media system in accordance with some embodiments of the disclosure, further describing determining whether a first product is related to a second product and automatically processing.

FIG. 6B shows process 650. Process 650 is one embodiment of the process used in step 586 (FIG. 5B) to compute a relationship metric between the first product information and the second product information, and the process used in step 588 (FIG. 5B), to determining whether the first product and second product are related based on the computed relationship metric. It should be understood that process 650 is just one embodiment and that other suitable methods may be used.

At step 652, process 650 initializes the counter. At step 654, process 650 initializes the relationship metric. The counter will be used to track the progression of process 650 through the array of data fields. The relationship metric will be a value used to determine whether or not two products are related. For example, the system may assign each a value of zero. At step 656, process 650 retrieves the first product information value based on the counter value. At step 658, the process 650 retrieves the second product information value based on the counter value. In some embodiments, analyzing the first and second product information may require a server to process the values of the data fields of the first and second product information. For example, the first and second product information may comprise an array of values. Each value may correspond to a particular trait or attribute of the product. The system may record or use those values as inputs in later steps.

At step 660, process 650 compares the first and second product information. For example, the server may compare corresponding data fields for the first product information and the second product information. The system may use multiple types of object recognition, including fuzzy logic. For example, the particular data field may be a textual data field. Using fuzzy logic, the system may determine two fields to be identical even though the substance of the data field (e.g., two different spellings) is not identical. In some embodiments, the server may analyze particular data fields of the first product information and the second product information for particular values or text. The data fields could be associated with categories, genres, series, episodes, products, traits, ratings, targeted audiences, textual descriptions, or any other suitable indicator. Furthermore, the data fields could contain values (e.g., the data fields could be expressed in binary or any other suitable code or programming language).

If the first product value equals the second product value, process 650 adds a value to the relationship metric at step 662. If the first product value does not equal the second product value, process 650 does not add a value to the relationship metric at step 664. In some embodiments, the amount of the value may be one. In some embodiments, the amount of the value may depend on the iteration (e.g., the particular counter number). For example, a particular counter number or data field may relate to a particular attribute that should be given more or less weight in the relationship metric.

At step 666, the process 650 determines if the counter has reached its maximum value. If the counter has not reached the maximum value, process 650 continues to step 670, which adds an increment to the counter, and returns to steps 656 and 658. If the counter has reached the maximum value, the process 650 determines whether the value of the relationship metric is above a threshold value at step 668. The particular threshold value may differ depending on the product. For example, a single data field match may determine that two products are related. In another example, the threshold may require a certain number of matches for the threshold to be met.

If the relationship metric value in step 668 is above the threshold value, the products may be deemed related. If the relationship metric value created in step 658 is below the threshold value, the products may be deemed unrelated. It should be noted a threshold value may also be computed using any suitable method or process to determine that the two products are related.

If the products are determined to be related, process 650 continues processing at step 674. Process 650 could be incorporated into any other embodiments or steps disclosed herein (e.g., FIG. 5B). In the example using FIG. 5B, a determination that the products are related may result in automatically processing the first product information and the first purchase history information to compute a lifetime for the first product when the first product and the second product are related at step 590 (FIG. 5B).

If the products are determined to not be related, process 650 will stop at step 672. In one possible example using FIG. 5B, a determination that the products are not related may result in the process stopping and not automatically processing the first product information and the first purchase history information to compute a lifetime for the first product when the first product and the second product are related at step 590 (FIG. 5B). In some embodiments, a determination that the products are not related may result in beginning process 650 again using a different first product and/or second product.

Any of the steps or embodiments described in relation to FIG. 6B may be performed by any of the devices shown in FIG. 4. For example, the advertisement database 416 (FIG. 4), remote server 418 (FIG. 4), purchase history database 424 (FIG. 4), user equipment 402, 404, and/or 406 (FIG. 4), and/or any device accessible via the communications network 414 (FIG. 4) may perform, or may combine to perform, any of the steps or embodiments described in relation to FIG. 6B.

It is contemplated that the steps or descriptions of FIG. 6B may be used with any other embodiment of this disclosure. In addition, the steps and descriptions described in relation to FIG. 6B may be done in alternative orders or in parallel to further the purposes of this disclosure. For example, each of these steps may be performed in any order or in parallel or substantially simultaneously to reduce lag or increase the speed of the system or method.

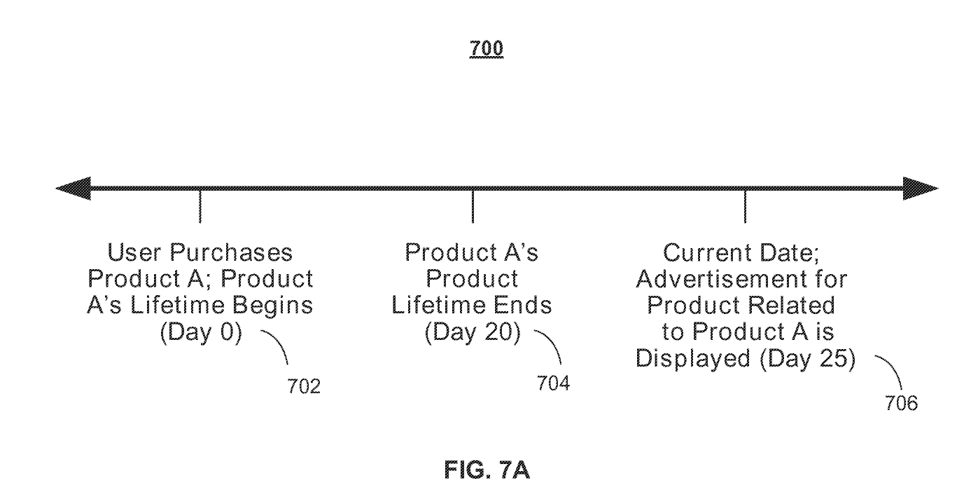

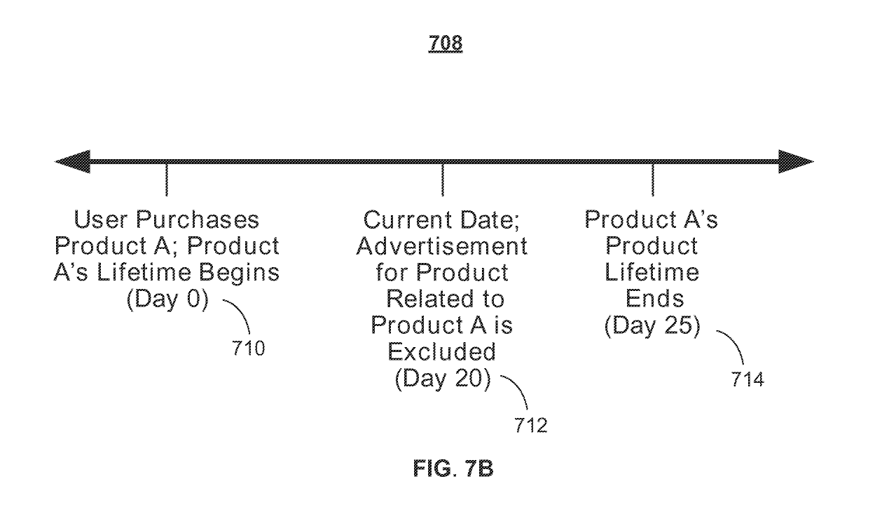

FIGS. 7A and 7B are timelines illustrating results involved in providing advertisements in a media system in accordance with some embodiments of the disclosure. The advertisement database 416 (FIG. 4), remote server 418 (FIG. 4), purchase history database 424 (FIG. 4), user equipment 402, 404, and/or 406 (FIG. 4), and/or any device accessible via the communications network 414 (FIG. 4) may perform any of the actions related to the positions on the timelines.

In FIG. 7A, timeline 700 shows a user purchases product A, which begins the lifetime of the product at position 702. Twenty days later product A's product lifetime ends at position 704. In timeline 700, the current date is twenty-five days after the user purchased product A. The current date is five days after product A's lifetime; therefore, an advertisement related to product A is displayed at position 706. For example, product A may be a cleaning product. Based on the user's profile, the user is likely to need more cleaning products in twenty days. Because it has been over twenty days, an advertisement for more cleaning products, which is related to product A, is displayed.

In some embodiments, a system may review all of the advertisements in the advertisement database 416 (FIG. 4) and cross-reference those advertisements with a purchase history from purchase history database 424 (FIG. 4). Upon determining that a particular advertisement is appropriate (e.g., the product lifetime of a product related to the advertised product has ended), the system may display the advertisement.

In FIG. 7B, timeline 708 shows a user purchases product A, which begins the lifetime of the product, at position 710. The current date is twenty days later, at position 712. Product A's product lifetime ends twenty-five days later, at position 714. Because the current date is during product A's product lifetime, the advertisement for a product related to product A is excluded at position 712. For example, product A may be software that has periodic updated versions released. Based on the user profile, the user is likely to purchase updated versions only after twenty-five days. Because it has been only twenty days, an advertisement for the updated version, which is related to product A, is excluded.

In some embodiments, a system performs several iterations until an advertisement is found that may be displayed. The system may review all of the advertisements in the advertisement database 416 (FIG. 4) and cross-reference those advertisements with a purchase history from purchase history database 424 (FIG. 4) before an advertisement is needed. Upon determining that an advertisement is needed, the system may provide a particular advertisement, which is appropriate (e.g., the product lifetime of a product related to the advertised product has ended).

FIG. 8 is a flowchart of illustrative steps involved in providing advertisements in a media system in accordance with some embodiments of the disclosure. By using any of the equipment described in relation to FIG. 4, the system may determine a particular product's lifetime, when the lifetime begins, and when the lifetime ends. The system may use this system to determine when a user may need or may be looking to purchase a new or related product. By targeting advertisements for the product to the particular person at this particular time, the system can increase the likelihood that the person will purchase the product.

At step 802 of process 800, the system may determine that an advertisement is needed. The determination may be in response from a request internal or external to the system. For example, the system may wish to send an e-mail advertisement to a user, but would like to increase the probability that a user will purchase the product. In some embodiments, the system may periodically or continuously analyze a user's profile to determine if there are any advertisements for products that are related to products in the user's purchase history. Therefore, in some embodiments, step 802 may be performed after the remaining steps in process 800.

The advertisement database 416 (FIG. 4), remote server 418 (FIG. 4), purchase history database 424 (FIG. 4), user equipment 402, 404, and/or 406 (FIG. 4), and/or any device accessible via the communications network 414 (FIG. 4) may accept or retrieve the request for an advertisement in step 802.

At step 804, the system retrieves a user purchase history. For example, the system may retrieve a user profile that contains a user purchase history. The advertisement database 416 (FIG. 4), remote server 418 (FIG. 4), purchase history database 424 (FIG. 4), user equipment 402, 404, and/or 406 (FIG. 4), and/or any device accessible via the communications network 414 (FIG. 4) may perform this step. Furthermore, the user profile and/or user purchase history may be retrieved from the purchase history database 424 (FIG. 4) and/or any device accessible via the communications network 414 (FIG. 4). For example, a user may have entered a website, which contains advertisements. Upon entrance by the user, the website may access the user's profile, purchase history, or both.

At step 806, the system determines if any advertised products are related to purchased products. In some embodiments, the system may determine if any products in the user's profile or purchase history are related to products for which the system has advertisements. For example, the system may have a plurality of advertisements, each advertisement having a different advertised product, and may select advertisements based on the presence of a related product in the user purchase history.

The advertisement database 416 (FIG. 4), remote server 418 (FIG. 4), purchase history database 424 (FIG. 4), user equipment 402, 404, and/or 406 (FIG. 4), and/or any device accessible via the communications network 414 (FIG. 4) may perform step 806.

At step 808, the system determines the user's product's lifetime of the purchased products in the user's profile or purchase history that are related to one or more advertised products. For example, the system may perform this step for multiple advertised products. The lifetime of the products in the user's profile or purchase history, which are related to one or more of the multiple advertisements, may be based on the lifetime function (EQ. 1) as discussed in relation to FIG. 6A.

This step may be performed by the advertisement database 416 (FIG. 4), remote server 418 (FIG. 4), purchase history database 424 (FIG. 4), user equipment 402, 404, and/or 406 (FIG. 4), and/or any device accessible via the communications network 414 (FIG. 4).

At step 810, the system may determine the proximity of the current date from the user's product's end date of each product related to an advertised product. In some embodiments, the user's product's end date may be calculated according to (EQ. 2) as discussed in relation to FIG. 6A.

The system may determine the current date, x. The current date may be determined by any suitable method discussed herein. For example, any method which reliably tracks the time or date may suffice.

The system may assign a value to the proximity, p, of the current date, x, to the user's product's end date, p. The value of the variable p may be calculated by any suitable method, where the greater the proximity of the current date to the user's product's end date, the greater the value of p. For example, if the end date is three days away from the current date for set A and one day away from set B, set B may have a higher value for p.

In some embodiments, the maximum value of p would be achieved when the likeliest end date is equal to the current date. For example, the value of p could be represented by a normal distribution. The likeliest end date could equal the highest value for p. As the current time moves away from the likeliest end date the value could decrease as discussed in more depth below and as shown in FIG. 9.

For example, the value of p could be represented by:

$$p = \frac{1}{σ \sqrt{2 π}} {e}^{- \frac{{( x - μ )}^{2}}{2 {σ}^{3}}} \qquad ( EQ . 3 )$$

In this case, σ² is the standard deviation and μ is the mean or expectation (location of the user's product's lifetime end date). The mean or expectation may be the sum of the product lifetime beginning date and the calculated lifetime from EQ. 1 above. The variable x represents the current time, and the value of p decreases as the current time moves away (either positively or negatively) from the likeliest end date.

For example, the p value of a particular advertisement will be greatest when the current date is the date calculated to be the user's product's lifetime end date. If the current date is before or after the user's product's lifetime end date, the p value of the particular advertisement will decrease. In some embodiments, the p value may be combined with the reliability of the data as shown below in EQ. 4.

Furthermore, in some embodiments, the system may set a minimum p value for displaying an advertisement. For example, if the p value of a particular advertisement is below a certain threshold value (e.g., the current date is too far away from the likeliest product lifetime end date), the advertisement may be excluded. It should also be noted that any measurement of time (e.g., days, hours, minutes, seconds) may be used interchangeably within the embodiments of this disclosure. For example, while some embodiments or descriptions in regard to some embodiments may describe the product lifetime in days, describing the product lifetime in other measurements is also contemplated by the disclosure.

The advertisement database 416 (FIG. 4), remote server 418 (FIG. 4), purchase history database 424 (FIG. 4), user equipment 402, 404, and/or 406 (FIG. 4), and/or any device accessible via the communications network 414 (FIG. 4) may perform step 810.

At step 812, the system may determine whether or not the current date is within an appropriate proximity to the product's lifetime's end date. The system may determine this based on p, the absolute value of p, and/or a combination of p with other weighted factors. In some embodiments, the system may use other appropriate equations, algorithms or methods to calculate the proximity of the current date to the user's product's end date.

If the particular advertisement is not within an appropriate proximity, the system may exclude the advertisement as shown at step 816. In some embodiments, another advertisement, which has an appropriate proximity, may be displayed instead as shown by the process 800 returning to step 812. If the particular advertisement is within the appropriate proximity, the advertisement may be displayed to the user at step 814.

The advertisement database 416 (FIG. 4), remote server 418 (FIG. 4), purchase history database 424 (FIG. 4), user equipment 402, 404, and/or 406 (FIG. 4), and/or any device accessible via the communications network 414 (FIG. 4) may perform step 812, and the advertisement database 416 (FIG. 4), remote server 418 (FIG. 4), purchase history database 424 (FIG. 4), user equipment 402, 404, and/or 406 (FIG. 4), and/or any device accessible via the communications network 414 (FIG. 4) may display and/or instruct another device to display the advertisement.

In some embodiments, a rating of the reliability of the end date calculation may be used. In some embodiments, the rating function may take the form of:

rating=pᵢrᵢ (EQ 4)

where p is the proximity of the current date from the user's product's end date of each advertisement's related product, and r is the reliability of the user's product's lifetime end date of each advertisement's related product. The variable p may be formulated such that the fewer days, hours, etc. away from the user's product's lifetime end date the higher the rating. The variable r may consider the reliability of the determination of the user's product's lifetime end date of each advertisement's related product.

For example, the end date of a product that is used for a set period of time (e.g., a yearly subscription) may be more reliable than the end date of a product that was heavily influenced by the particular user (e.g., a book). The rating may also be scaled, if desired, so that, for example, all the scores have a maximum value of 100 (or any other convenient number). In general, the higher the rating, the more appropriate the advertisement will be to the user's current needs. In addition, the rating may be used to prioritize, or rank, advertisements. For example, advertisements with higher ratings may be ranked higher than content with lower ratings, and may, therefore, be preferred over other advertisements. Furthermore, the system may require that an advertisement has a particular rating or proximity.

In some embodiments, the system may determine whether or not a particular advertisement has the highest rating of the multiple advertisements. In some embodiments, the system may determine whether or not the rating is high enough to display to the user irrespective of other advertisements. If the rating of a particular advertisement is not the highest, the system may exclude the advertisement, and may determine a different advertisement to display. If the rating of a particular advertisement is the highest, the advertisement may be displayed to the user on the user devices 402, 404, 406 (FIG. 4).

The advertisement database 416 (FIG. 4), remote server 418 (FIG. 4), purchase history database 424 (FIG. 4), user equipment 402, 404, and/or 406 (FIG. 4), and/or any device accessible via the communications network 414 (FIG. 4) may perform any of the steps or algorithms used in determining a rating.

It is contemplated that the steps or descriptions of FIG. 8 may be used with any other embodiment of this disclosure. In addition, the steps and descriptions described in relation to FIG. 8 may be done in alternative orders or in parallel to further the purposes of this disclosure. For example, each of these steps may be performed in any order or in parallel or substantially simultaneously to reduce lag or increase the speed of the system or method.

FIG. 9 shows graph 900 depicting the value assigned to the current date, when the current date is near the user's product's end date. For example, the proximity, p, of the current date may decrease as the time moves away, both positively and negatively, from the user's product's end date. For example, an advertisement may have a minimal p value if the current date is three or more days before or after the user's product's end date.

In FIG. 9, the user's product's end date is represented by the date zero. The time may be represented in any appropriate increment such as days, hours, etc. It should also be noted that the user's product's end date may equal the date the user is likely to begin thinking about purchasing a new product related to the user's current product, which may be in advance of when the user actually purchases a new product. In some embodiments, the product's end date may represent a range of time for which an advertisement for a product related to a user's product may be effectively displayed to the user. For example, the end date may be bordered by a certain (positive and negative) value of p as shown in FIG. 9. Therefore, only advertisements where the product related to the advertised product has a certain threshold value of p may be displayed.

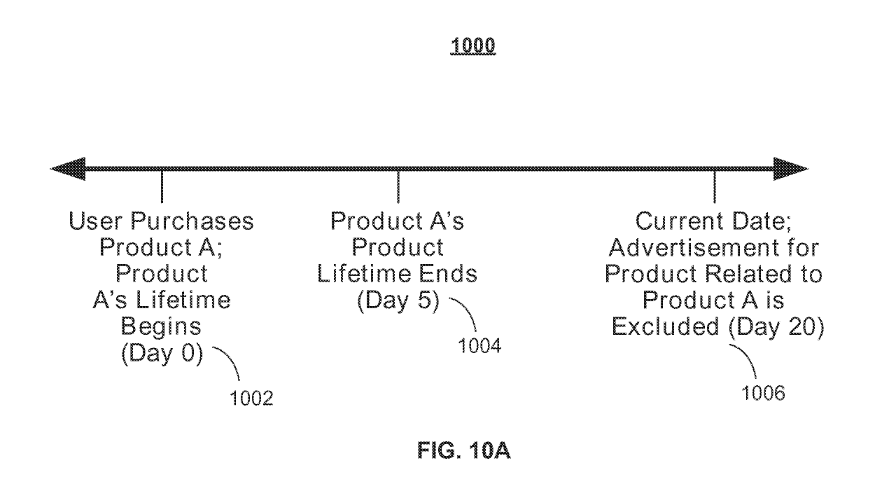

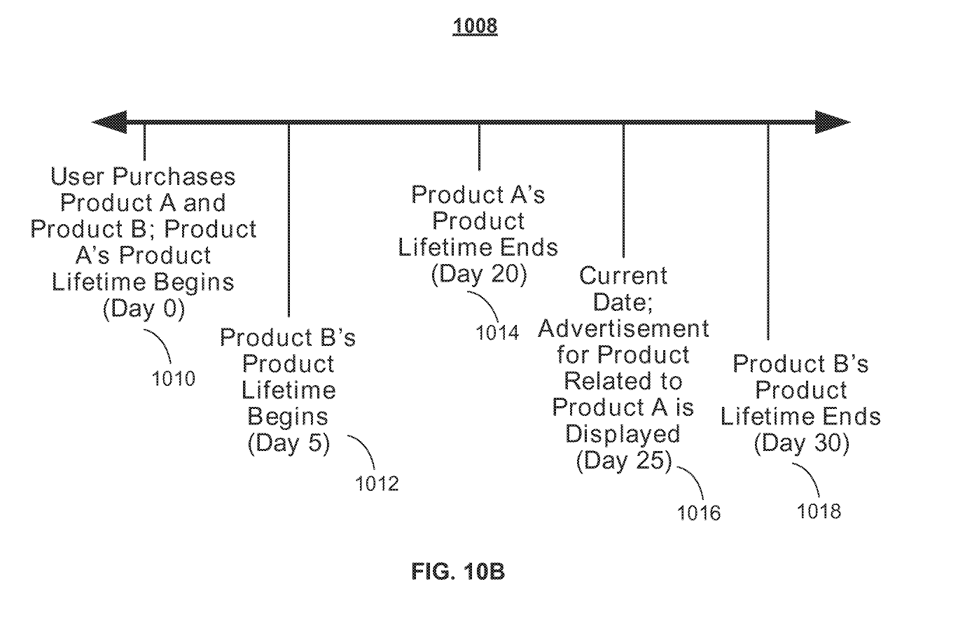

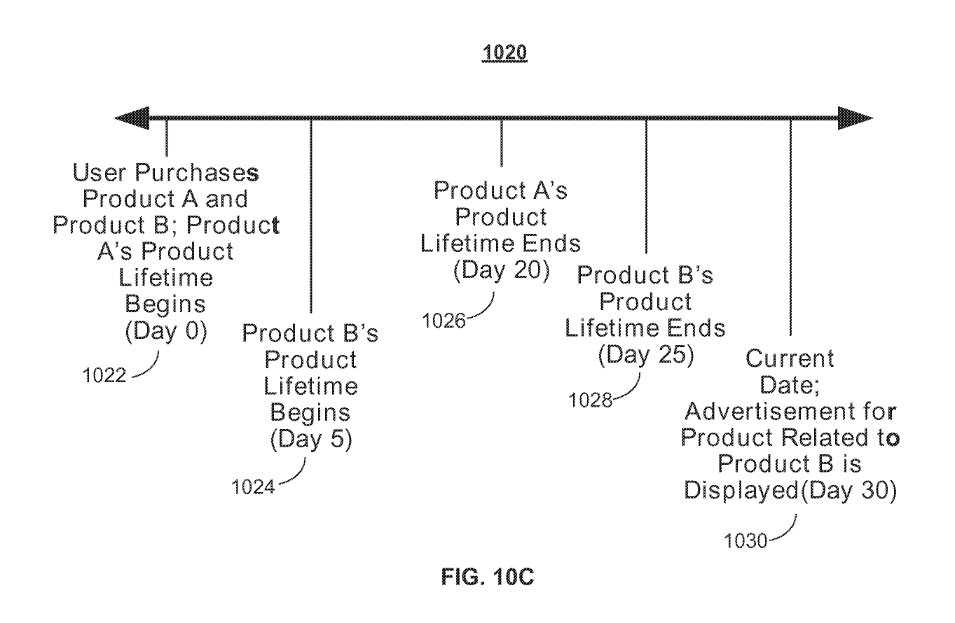

FIGS. 10A-C are timelines illustrating results involved in providing advertisements in a media system in accordance with some embodiments of the disclosure. The advertisement database 416 (FIG. 4), remote server 418 (FIG. 4), purchase history database 424 (FIG. 4), user equipment 402, 404, and/or 406 (FIG. 4), and/or any device accessible via the communications network 414 (FIG. 4) may perform any of the actions related to the positions on the timelines.

FIG. 10A is a timeline illustrating steps involved in providing advertisements in a media system in accordance with some embodiments of the disclosure. Specifically, FIG. 10A shows timeline 1000, which provides an example of an advertisement being excluded due to the proximity of the user's product's lifetime end date of the product related to the advertised product and the current date.

In FIG. 10A, timeline 1000 shows that a user purchases product A, which begins the lifetime of the product, at position 1002. The current date is twenty days later, at position 1006. Product A's product lifetime ended five days after the user purchased product A, at position 1004. At position 1006, because the current date is so long after the end of product A's product lifetime, the advertisement for a product related to product A may be excluded. In some embodiments, the proximity of the current date to the user's product's lifetime end date may be too low (e.g., below a threshold) for the advertisement for a product related to product A to be shown. In some embodiments, the rating of the advertisement may be too low (e.g., below a threshold) for the advertisement for a product related to product A to be shown. For example, the system may determine that the window, based on a user and/or product profile, for providing a user with a new product related to a prior purchase has closed (e.g., the user has likely already purchased a replacement product). Therefore, the system may not wish to advertise a related product.

FIG. 10B is a timeline illustrating steps involved in providing advertisements in a media system in accordance with some embodiments of the disclosure. Specifically, FIG. 10B shows timeline 1008, which provides an example of which advertisement would be displayed based on the relative product lifetime of a product related to the product of the advertisement.

In FIG. 10B, a user purchases product A and product B at position 1010. The system may determine this by any of the behavior observation techniques discussed above. Based on the user profile, the product or any other factors discussed above, the product lifetime begins for product A; however, the product lifetime for product B does not begin until five days later at position 1012.

Twenty days after the purchase of product A, product A's product lifetime ends at position 1014. The current date is twenty-five days after the purchase of product A and product B. Because product A's lifetime has ended, the advertisement for a product related to product A is displayed to a user at position 1016. Because the product lifetime for product B does not end until thirty days after the purchase of product B (or twenty-five days after the beginning of product B's product lifetime) at position 1018, the advertisement for a product related to product B is not displayed.

FIG. 10C is a timeline illustrating steps involved in providing advertisements in a media system in accordance with some embodiments of the disclosure. Specifically, FIG. 10C illustrates an embodiment where the system determines which advertisement to display when two products a user has purchased are related to two advertised products.

At position 1022 of timeline 1020, a user purchases product A and product B. Product A's product lifetime begins upon purchase. This may be based on the product or the user's profile or a combination of both. Product A and product B may or may not be related to each other. For example, product A and product B could both be movies of the same genre. Alternatively, product A could be a monthly bus pass and product B could be a set of hair salon appointments. Based on the user's profile, product information, or both, product A's lifetime begins upon purchase. In this case, product B's lifetime begins upon the use of the first appointment five days later at position 1024.

At position 1026, product A's product lifetime ends twenty days after purchase. Product B's product lifetime ends five days later at position 1028. The end of product B's lifetime may be the result of additional observed behavior (e.g., the use of the last appointment of the set of appointments) or based on the user's profile or product information.

The current date is thirty days after the user purchased products A and B at position 1030. Both of the lifetimes for product A and product B have ended. However, the system may determine that the end of product B's lifetime is more recent (e.g., has a higher proximity to the current date as described above); therefore, the system may determine that an advertisement for a product related to product B should be displayed to the user. For example, the system may believe that the user has likely already found a replacement for product A, so a targeted advertisement for a product related to product A would be less effective.

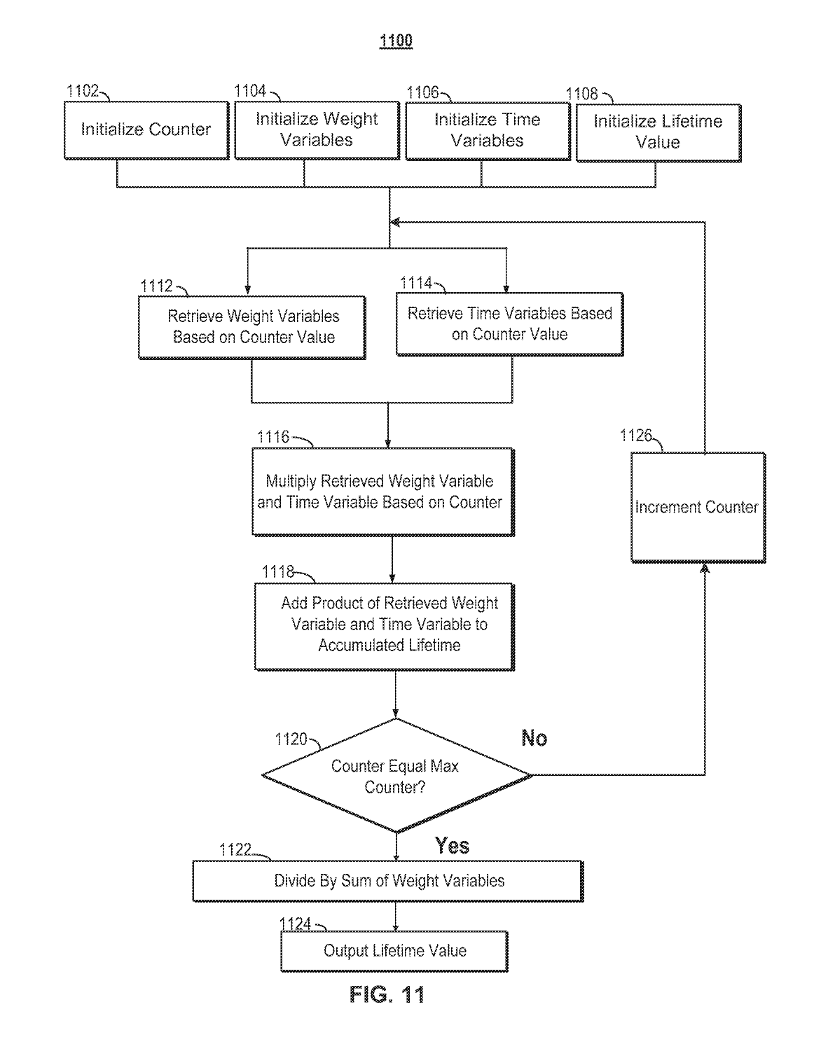

FIG. 11 is a flowchart of an illustrative process used to determine a lifetime associated with a product previously purchased by a user. For example, the steps shown and described in FIG. 11 may represent the processes occurring at step 610 (FIG. 6A).

The illustrative embodiments of process 1100 depict steps performed in accordance with EQ. 1. The advertisement database 416 (FIG. 4), remote server 418 (FIG. 4), purchase history database 424 (FIG. 4), user equipment 402, 404, and/or 406 (FIG. 4), and/or any device accessible via the communications network 414 (FIG. 4) may perform any of the steps of FIG. 11.

Process 1100 begins by initializing several variables. Specifically, process 1100 initializes a counter at step 1102, weight variables at step 1104, time variables at step 1106, and lifetime value at step 1108. Each of the variables may correspond to variables discussed in relation to FIG. 6A and may be stored in an array of one through N entries. For example, process 1100 may describe each iteration beginning with the first iteration and ending with the Nth iteration.

After the counter, weight variables, time variables, and lifetime value are initialized in steps 1102, 1104, 1106, and 1108, respectively, process 1100 retrieves a weight based on the counter at step 1112 and a time based on the counter at step 1114. The particular weight variables and/or time variables may vary depending on the user profile, the product profile, or other observed behaviors as described in relation to the descriptions in FIGS. 5-6. For example, two users may have different factors and/or weights associated with the lifetime calculation for the same product.

At step 1116, process 1100 multiplies the time and weight variables retrieved in steps 1112 and 1114, respectively. At step 1118, process 1100 adds the product of step 1116 to the accumulated lifetime. At step 1120, the system determines if the counter equals the maximum counter value (e.g., whether there are additional iterations that need to be performed). If there are additional iterations, the system may return to steps 1112 and 1114 and repeat the process after increasing the counter by an increment at step 1126. If there are no more iterations (e.g., the counter has reached the maximum N value), the system may divide the sum of the iterations by the sum of the weight associated with each iteration at step 1122 to obtain the arithmetic mean and output the lifetime of the product at step 1124.

It is contemplated that the steps or descriptions of FIG. 11 may be used with any other embodiment of this disclosure. In addition, the steps and descriptions described in relation to FIG. 11 may be done in alternative orders or in parallel to further the purposes of this disclosure. For example, each of these steps may be performed in any order or in parallel or substantially simultaneously to reduce lag or increase the speed of the system or method.

Furthermore, FIG. 11 (and EQ. 1) is but one possible process for determining the lifetime of a product. One of skill in the art would understand that other processes, algorithms, and methods may also be used.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel.

1. A method for targeting an advertisement to a user, comprising:
transmitting, from a server, a query for first purchase history information and first product information, wherein the query comprises a first product identifier for a first product and a user identifier;
receiving a plurality of data packets comprising the first product information and the first purchase history information in response to the query;
computing, using control circuitry, a relationship metric between the first product information and second product information for a second product;
determining whether the first product and the second product are related based on the computed relationship metric;
automatically processing the first product information and the first purchase history information to compute a lifetime for the first product when the first product and the second product are related;
comparing, using control circuitry, a current date and the lifetime of the first product to determine whether the current date is outside the lifetime of the first product; and
generating, using control circuitry, an instruction for presenting an advertisement for the second product on a device when the current date is outside the lifetime of the first product.

2. The method of claim 1, wherein the first product information comprises a user profile.

3. The method of claim 1, wherein the lifetime begins when the user purchases the first product.

4. The method of claim 1, wherein the lifetime begins when the user initially used the first product.

5. The method of claim 1, further comprising:
computing an end date of the lifetime; and
determining the proximity of the current date to the end date of the lifetime.

6. The method of claim 1, wherein computing the relationship metric between the first product information and the second product information for a second product comprises comparing data fields in the first product information to data fields in the second product information.

7. The method of claim 1, wherein computing the relationship metric between the first product information and the second product information for a second product comprises comparing words in a product description field in the first product information to words in a product description field in the second product information.

8. The method of claim 1, wherein the lifetime of the first product ends at a predetermined time when the user is likely to want the second product.

9. The method of claim 8, further comprising scheduling the advertisement to be presented to the user after the end of the lifetime of the first product, if the current date is within the lifetime of the first product.

10. The method of claim 8, further comprising excluding the advertisement after a predetermined amount of time after the end of the lifetime of the first product.

11. A system for targeting an advertisement to a user, comprising:
a server configured to:
transmit a query for first purchase history information and first product information, wherein the query comprises a first product identifier for a first product and a user identifier; and
receive a plurality of data packets comprising the first product information and the first purchase history information in response to the query;
control circuitry configured to:
compute a relationship metric between the first product information and second product information for a second product;
determine whether the first product and the second product are related based on the computed relationship metric;
automatically process the first product information and the first purchase history information to compute a lifetime for the first product when the first product and the second product are related;
compare a current date and the lifetime of the first product to determine whether the current date is outside the lifetime of the first product; and
generate an instruction for presenting an advertisement for the second product on a device when the current date is outside the lifetime of the first product.

12. The system of claim 11, wherein the first product information comprises a user profile.

13. The system of claim 11, wherein the lifetime begins when the user purchases the first product.

14. The system of claim 11, wherein the lifetime begins when the user initially used the first product.

15. The system of claim 11, wherein the control circuitry is further configured to:
compute an end date of the lifetime; and
determine the proximity of the current date to the end date of the lifetime.

16. The system of claim 11, wherein computing the relationship metric between the first product information and the second product information for a second product comprises comparing data fields in the first product information to data fields in the second product information.

17. The system of claim 11, wherein computing the relationship metric between the first product information and the second product information for a second product comprises comparing words in a product description field in the first product information to words in a product description field in the second product information.

18. The system of claim 11, wherein the lifetime of the first product ends at a predetermined time when the user is likely to want the second product.

19. The system of claim 18, wherein the server is further configured to schedule the advertisement to be presented to the user after the end of the lifetime of the first product, if the current date is within the lifetime of the first product.

20. The system of claim 18, wherein the server is further configured to exclude the advertisement after a predetermined amount of time after the end of the lifetime of the first product.

21-30. (canceled)
